(19) United States
(12) Patent Application Publication
(10) Pub. No.: US 2025/0007376 A1
(43) Pub. Date: Jan. 2, 2025

(54) IN-WHEEL MOTOR

(71) Applicant: ISUZU MOTORS LIMITED, Yokohama-shi, Kanagawa (JP)

(72) Inventor: Mitsuhiro ASO, Fujisawa-shi, Kanagawa (JP)

(21) Appl. No.: 18/709,606

(22) PCT Filed: Sep. 15, 2022
(86) PCT No.: PCT/JP2022/034497

§ 371 Date: May 13, 2024

(30) Foreign Application Priority Data
Nov. 18, 2021 (JP) 2021-187894

(51) Int. Cl. H02K 24/00; B60K 7/00; H02K 11/225; H02K 21/22

(52) U.S. Cl. CPC H02K 24/00; B60K 7/0007; H02K 11/225; H02K 21/22; B60K 2007/0092

(57) ABSTRACT

Provided is an in-wheel motor with which phase matching of a sensor and a magnet can be easily carried out. This in-wheel motor is an outer rotor-type in-wheel motor comprising a stator and a rotor. The in-wheel motor comprises: a sensor that senses the rotation state of the rotor; an attachable/detachable member that can be attached to and detached from the rotor, and that has a surface which opposes the inner circumferential surface of the stator and on which the sensor is provided; and a positioning part that, when the attachable/detachable member has been attached to the rotor, defines a positional relationship between the sensor and a magnet of the rotor so that a phase difference between the sensor and the magnet reaches a set value.

### TECHNICAL FIELD

The present disclosure relates to an in-wheel motor.

### BACKGROUND ART

In the related art, there is known an in-wheel motor of an outer rotor type including a stator and a rotor (for example, see Patent Literatures (hereinafter, “Patent Literature” will be referred to as “PTL”) 1 and 2).

### CITATION LIST

### Patent Literature

### PTL 1

Japanese Patent Application Laid-Open No. 2020-157837 PTL 2
Japanese Patent Application Laid-Open No. 2020-114054

### SUMMARY OF INVENTION

### Technical Problem

For example, an in-wheel motor of an outer rotor type having a configuration in which a rotating member that is secured to a rotor and rotates together with the rotor is provided and the rotating member is provided with a sensor that detects the rotational state of the rotor can be considered. In this case, it is necessary to perform phase matching of the sensor provided in the rotating member and a magnet provided in the rotor. There is a problem, however, in that in a case where the rotating member is once detached from the rotor and is reattached to the rotor after the phase matching, it is difficult to perform the phase matching of the sensor and the magnet.

An object of an aspect of the present disclosure is to provide an in-wheel motor that makes it possible to perform phase matching of a sensor and a magnet easily.

### Solution to Problem

An in-wheel motor according to an aspect of the present disclosure is an in-wheel motor of an outer rotor type including a stator and a rotor. The in-wheel motor includes: a sensor which detects a rotational state of the rotor; an attachable/detachable member attachable to and detachable from the rotor and is provided with the sensor on a surface facing an inner circumferential surface of the stator; and a positioning part that defines a positional relationship between the sensor and a magnet of the rotor such that a phase difference between the sensor and the magnet reaches a set value when the attachable/detachable member is attached to the rotor.

### Advantageous Effects of Invention

According to the present disclosure, it is possible to perform phase matching of a sensor and a magnet easily.

### BRIEF DESCRIPTION OF DRAWINGS

FIG. 1 is a perspective view of a wheel assembly including an in-wheel motor according to an embodiment of the present disclosure as viewed from an outer side in the width direction of the wheel assembly;

FIG. 2 is a cross-sectional schematic view of the wheel assembly and the in-wheel motor according to the embodiment of the present disclosure;

FIG. 3 is an exploded perspective view of the in-wheel motor according to the embodiment of the present disclosure;

FIG. 4 is an exploded perspective cross-sectional view of the in-wheel motor according to the embodiment of the present disclosure; and

FIG. 5 is an exploded perspective view of components that are attached to a rotor according to the embodiment of the present disclosure.

### DESCRIPTION OF EMBODIMENTS

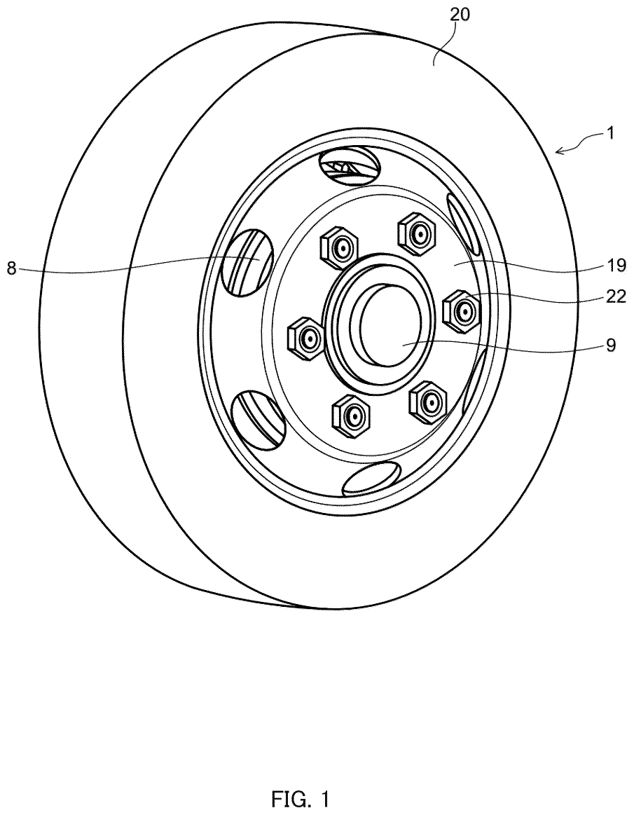

Hereinafter, the configurations of wheel assembly 100 and in-wheel motor 1 according to an embodiment of the present disclosure will be described with reference to FIGS. 1 to 5. In FIGS. 1 to 5, common components are denoted by the same reference signs.

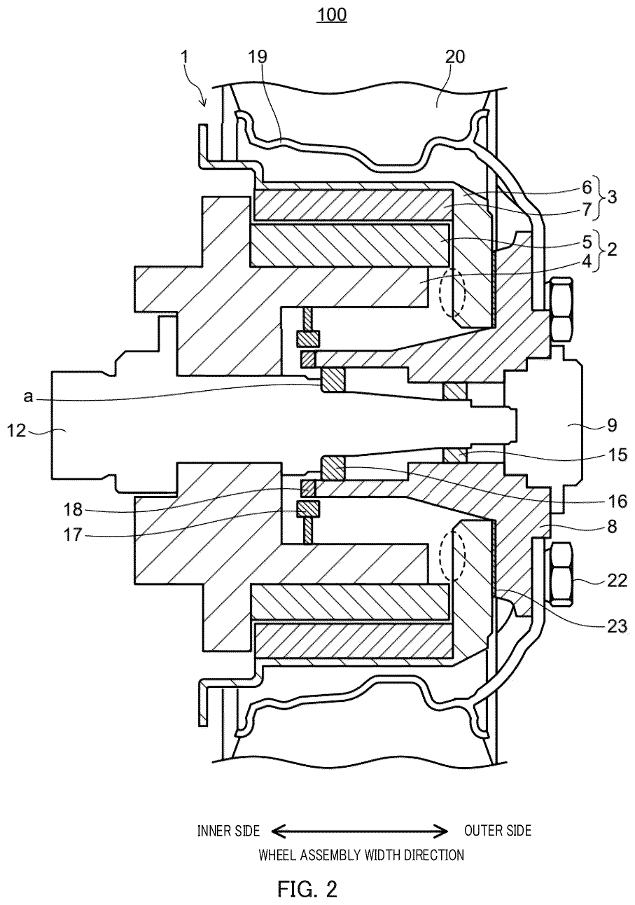

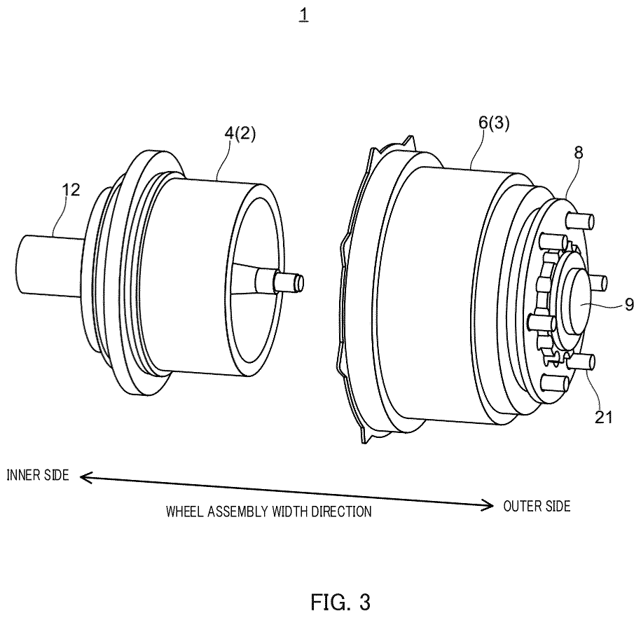

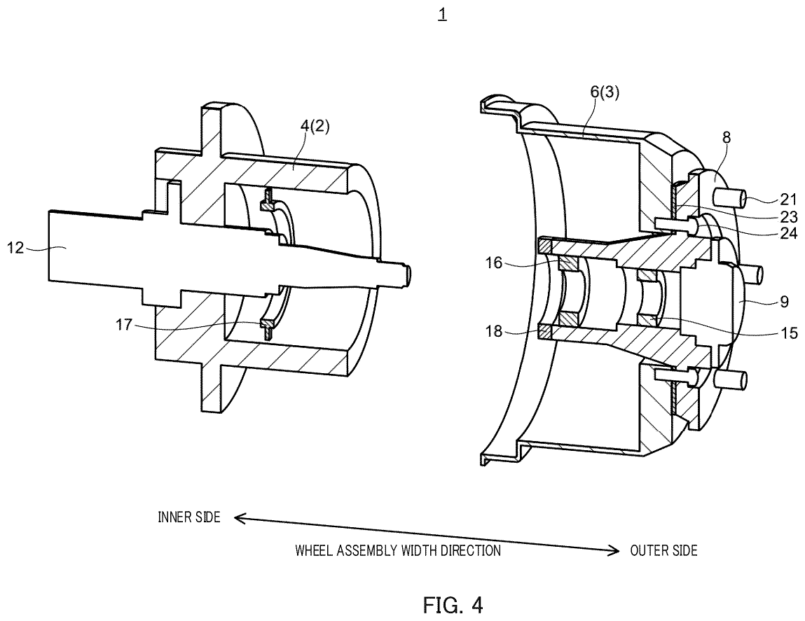

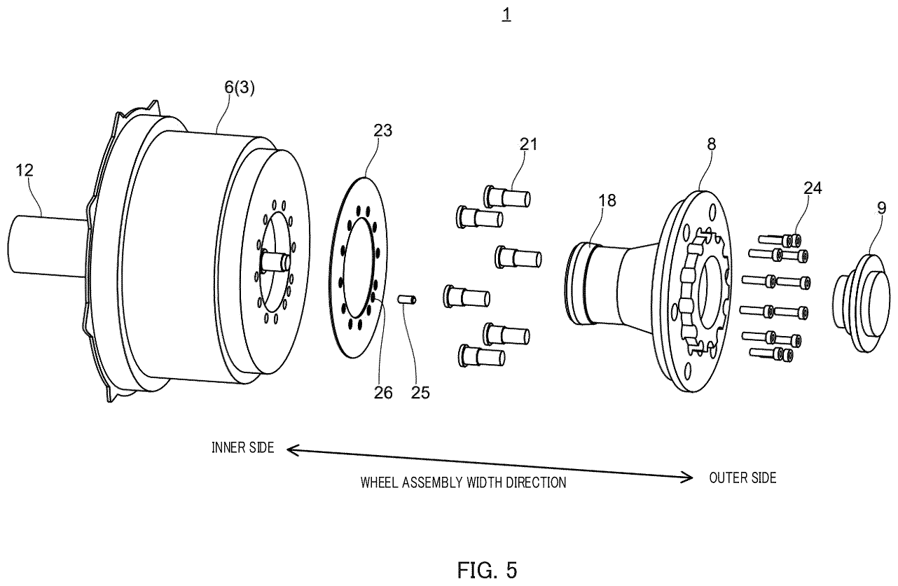

FIG. 1 is a perspective view of wheel assembly 100 including in-wheel motor 1 as viewed from an outer side in the width direction of wheel assembly 100. FIG. 2 is a cross-sectional schematic view of wheel assembly 100 and in-wheel motor 1. FIG. 3 is an exploded perspective view of in-wheel motor 1. FIG. 4 is an exploded perspective cross-sectional view of in-wheel motor 1. FIG. 5 is an exploded perspective view of components that are attached to rotor 3.

Note that, the bidirectional arrow with a straight line in FIGS. 2 to 5 indicates the width direction of wheel assembly 100 (which may also be referred to as the vehicle width direction). Hereinafter, an outer side in the width direction of wheel assembly 100 will be referred to as “the outer side in the wheel assembly width direction”, and an inner side in the width direction of wheel assembly 100 will be referred to as “the inner side in the wheel assembly width direction”.

Wheel assembly 100 illustrated in FIGS. 1 and 2 is used as, for example, a driving wheel of an automobile. As illustrated in FIGS. 1 and 2, wheel assembly 100 includes in-wheel motor 1, wheel 19, and tire 20.

Wheel 19 holds tire 20 (see FIGS. 1 and 2) and is secured to hub 8 (to be described in detail later) by stud bolts 21 (see FIGS. 3 to 5) and nuts 22 (see FIGS. 1 and 2).

In-wheel motor 1 illustrated in FIGS. 1 to 5 is an in-wheel motor of an outer rotor type.

As illustrated in FIGS. 1 to 5, in-wheel motor 1 includes stator 2, rotor 3, hub 8, cap 9, shaft 12, outer hub bearing 15, inner hub bearing 16, outer resolver 17, inner resolver 18, friction seal 23, bolts 24, and positioning pin 25. Having said that, not all of those described above are essential components.

As illustrated in FIG. 2, stator 2 includes stator body 4 having a substantially hollow cylindrical shape (see FIGS. 3 and 4), and coil 5 that is secured to the outer circumferential surface of stator body 4. Although illustration is omitted, coil 5 is a coil of a plurality of phases (for example, three phases). For example, a three-phase AC wire (not illustrated) is connected to coil 5, and a current is supplied to coil 5 via the wire by the control of an inverter (not illustrated). Note that, illustration of coil 5 is omitted in FIGS. 3 and 4.

As illustrated in FIG. 2, rotor 3 includes rotor case 6 having a substantially hollow cylindrical shape (see FIGS. 3 to 5), and magnet 7 that is secured to the inner circumferential surface of rotor case 6. Note that, illustration of magnet 7 is omitted in FIG. 4.

As illustrated in FIG. 2, stator 2 is disposed on the inner side of rotor 3. In other words, rotor 3 is disposed on the outer side of stator 2. At this time, magnet 7 of rotor 3 and coil 5 of stator body 4 are disposed to face each other at a predetermined distance. That is, a defined clearance is maintained between magnet 7 and coil 5.

Note that, although illustration is omitted, the end part of stator body 4 on the inner side in the wheel assembly width direction is provided with, for example, a cooling water supply port, a cooling water discharge port, a three-phase AC wire connector, a resolver signal connector, and/or the like.

The cooling water supply port and the cooling water discharge port are connected to a cooling water channel (not illustrated) provided within stator body 4. Cooling water for cooling in-wheel motor 1 flows from the cooling water supply port into the cooling water channel, flows through the cooling water channel, and is then discharged from the cooling water discharge port.

The three-phase AC wire connector is connected to the three-phase AC wire described above, and functions as an inlet of the current to be supplied to coil 5.

The resolver signal connector is connected to outer resolver 17 via a signal line (not illustrated), and functions as an outlet of a signal to be outputted from outer resolver 17 (for example, a signal indicating the detected rotation angle and rotation direction of rotor 3).

As illustrated in FIGS. 2 to 5, shaft 12 is a long member that is inserted into in-wheel motor 1 along the wheel assembly width direction. As illustrated in FIG. 2, shaft 12 is provided in contact with stator body 4 and is secured to stator body 4 by bolts (not illustrated).

The end part of shaft 12 on the inner side in the wheel assembly width direction is attached to, for example, a knuckle of a front wheel assembly or to a suspension arm of a rear wheel assembly (both of which are not illustrated). Note that, for the attachment thereof, a spline shape for being fitted into the knuckle or the suspension arm may be formed in the end part of shaft 12 on the inner side in the wheel assembly width direction.

The end part of shaft 12 on the outer side in the wheel assembly width direction is, on the other hand, inserted into a hollow portion (whose reference sign is omitted) provided in hub 8 in the axial direction thereof (the same as the wheel assembly width direction; the same applies hereinafter) as illustrated in FIG. 2.

Hub 8 (an example of the attachable/detachable member) illustrated in FIGS. 1 to 5 is a member attachable to and detachable from rotor case 6. The reason for configuring hub 8 to be attachable to and detachable from rotor case 6 is to enable maintenance (for example, replacement of hub 8 itself, and replacement of outer hub bearing 15 and/or inner hub bearing 16 provided in hub 8, or the like) to be easily performed.

As illustrated in FIGS. 2 to 5, hub 8 includes a tubular body (whose reference sign is omitted) disposed within rotor case 6, and a flange (whose reference sign is omitted) provided continuously to the tubular body and disposed outside rotor case 6. Further, hub 8 is provided with a hollow portion (a portion into which an end part of shaft 12 is inserted) that penetrates the tubular body and the flange in the axial direction.

The tubular body includes, as the outer circumferential surface, a surface facing the inner circumferential surface of stator body 4 (see FIG. 2).

The flange is disposed to face the outer surface (specifically, a surface where an opening part serving as an insertion/extraction port for the tubular body is provided) of rotor 3 (see FIGS. 4 and 5). The flange is provided with holes into which stud bolts 21, bolts 24, and positioning pin 25 are inserted, respectively (see FIG. 5). Wheel 19 that holds tire 20 is secured to the flange by stud bolts 21 (see FIGS. 3 to 5) and by nuts 22 (see FIGS. 1 and 2).

Bolts 24 illustrated in FIG. 5 are inserted from the outer side in the wheel assembly width direction into bolt holes (whose reference signs are omitted, respectively) provided in the flange of hub 8, friction seal 23 (to be described in detail later), and rotor case 6, respectively, and are fastened, as illustrated in FIGS. 2 to 4, to rotor case 6. Thus, hub 8 is secured to rotor 3 via friction seal 23. Note that, illustration of bolts 24 is omitted in FIG. 2, and illustration of friction seal 23 is omitted in FIG. 3.

As rotor 3 rotates, hub 8 secured to rotor 3 rotates. Accordingly, it can also be said that hub 8 is a rotating member.

Cap 9 illustrated in FIG. 5 is attached to an inner diameter hole (see FIG. 5; whose reference sign is omitted) in the center of the flange of hub 8 as illustrated in FIGS. 2 to 4.

Rotor case 6 to which hub 8 is secured (see FIGS. 3 and 4) is assembled to stator body 4 and is bolted to stator body 4. Thus, as illustrated in FIG. 2, stator 2 is disposed on the inner side of rotor 3 and the tubular body of hub 8 is disposed on the inner side of stator 2. At this time, the tubular body is disposed such that the outer circumferential surface thereof faces the inner circumferential surface of stator 2 at a predetermined distance (see FIG. 2).

Further, as described above, a portion of shaft 12 on the outer side in the wheel assembly width direction is inserted into (disposed within) the tubular body of hub 8 (that is, a hollow portion of the tubular body, where the hollow portion is provided in the axial direction thereof) as illustrated in FIG. 2. Note that, at this time, a leading-end portion of shaft 12 does not come into contact with cap 9.

Within the tubular body of hub 8, outer hub bearing 15 is provided on the outer side in the wheel assembly width direction, and inner hub bearing 16 is provided on the inner side of outer hub bearing 15 in the wheel assembly width direction as illustrated in FIGS. 2 and 4. Inner hub bearing 16 is disposed close (adjacent) to a leading-end portion of the tubular body of hub 8 in the axial direction of the tubular body of hub 8. Further, as illustrated in FIG. 2, inner hub bearing 16 is provided pressed against stepped portion a provided in shaft 12.

As illustrated in FIG. 2, both outer hub bearing 15 and inner hub bearing 16 are in contact with the outer circumferential surface of shaft 12 and the inner circumferential surface of the hollow portion of the tubular body of hub 8. Thus, the load from tire 20 can be supported by hub 8, outer hub bearing 15, inner hub bearing 16, and shaft 12, and it is possible to suppress transmission of the load to in-wheel motor 1.

Outer resolver 17 and inner resolver 18 illustrated in FIGS. 2 and 4 are resolvers (examples of the sensor) that detect the rotational state (for example, the rotation angle and rotation direction) of rotor 3.

As illustrated in FIGS. 2 and 4, outer resolver 17 (resolver stator) is secured to stator body 4.

As illustrated in FIGS. 2 and 4, inner resolver 18 (resolver rotor) is secured to the leading-end portion of the tubular body of hub 8. Thus, inner resolver 18 is disposed close to inner hub bearing 16 in the axial direction of the tubular body of hub 8. Inner resolver 18 disposed in the above-described manner rotates together with hub 8.

As illustrated in FIG. 2, outer resolver 17 and inner resolver 18 are disposed to face each other at a predetermined distance. That is, a defined clearance is maintained between outer resolver 17 and inner resolver 18.

As described above, the signal to be outputted from outer resolver 17 is outputted to the outside of in-wheel motor 1 via the signal line and the resolver signal connector (illustration of the both is omitted) which are connected to outer resolver 17.

Positioning pin 25 and positioning pin hole 26 both of which are illustrated in FIG. 5 function as the positioning part that defines the positional relationship between inner resolver 18 and magnet 7 such that the phase difference between inner resolver 18 provided in hub 8 and magnet 7 provided in rotor 3 reaches a set value (for example, zero, or a value within a range in which zero is used as a reference) when hub 8 is attached to rotor 3 (specifically rotor case 6).

As illustrated in FIG. 5, positioning pin 25 (an example of a fitting member) is a cylindrical member which is attachable to and detachable from each of rotor case 6, friction seal 23, and hub 8. As positioning pin 25, a dowel pin can be used, but the present disclosure is not limited thereto and a knock pin may also be used.

Positioning pin hole 26 (an example of a fitted part) is a hole into which positioning pin 25 is inserted, and is provided in each of rotor case 6, friction seal 23, and hub 8 (flange). The diameter of positioning pin hole 26 is smaller than the diameter of the bolt hole for bolt 24. In FIG. 5, only the positioning pin hole in friction seal 23 is denoted by the reference sign “26” as a representative example.

Positioning pin hole 26 is provided in a position such that inner resolver 18 and magnet 7 have a defined positional relationship (a positional relationship in which the phase difference between the both reaches a set value) when hub 8 to which inner resolver 18 is attached (see FIG. 5) is assembled to rotor case 6 to which magnet 7 is attached (see FIG. 4). The defined positional relationship is determined, for example, by positional adjustment performed at the time of manufacturing of in-wheel motor 1.

Positioning pin 25 is inserted into each positioning pin hole 26 when bolts 24 are inserted into the respective bolt holes and hub 8 is secured to rotor case 6.

Note that, although a case where positioning pin hole 26 is provided mixed with a plurality of bolt holes (holes for bolts 24) provided along the circumferential direction has been described as an example in FIG. 5, the position of positioning pin hole 26 is not limited thereto.

Further, although illustration is omitted, the shape of positioning pin hole 26 inside rotor case 6 may be a long hole shape extending in the radiation direction (the radial direction of rotor case 6). Thus, it is possible to absorb variations at the time of mass production.

As illustrated in FIG. 5, friction seal 23 (an example of a friction member) is a circular member including an inner diameter hole (whose reference sign is omitted).

As described above, friction seal 23 is secured, together with hub 8, to rotor case 6 by bolts 24 when hub 8 is assembled to rotor case 6. Thus, friction seal 23 is disposed between rotor case 6 and hub 8 (flange) as illustrated in FIGS. 2 and 4.

Friction seal 23 has a predetermined frictional coefficient. This frictional coefficient is set to a desired value based on, for example, the torque of rotor 3, the diameter of friction seal 23, the pressing pressure of hub 8 against rotor case 6, the number of bolts 24 to be used, the tightening torque of bolts 24 or the like.

The material of friction seal 23 is, for example, a composite material obtained by mixing a fiber material with rubber or the like and then rolling and vulcanizing the mixture, but the present disclosure is not limited thereto.

The configurations of wheel assembly 100 and in-wheel motor 1 in the present embodiment have been described above.

The main features of in-wheel motor 1 in the present embodiment will be summarized as follows.

The first feature is that in-wheel motor 1 is an in-wheel motor of an outer rotor type, and includes: inner resolver 18 which detects the rotational state of rotor 3; hub 8 which is attachable to and detachable from rotor 3 (specifically, rotor case 6) and is provided with inner resolver 18 on a surface facing the inner circumferential surface of stator 2 (specifically, stator body 4); and friction seal 23 which is provided between rotor 3 and hub 8 and is secured, together with hub 8, to rotor 3.

The first feature causes a frictional force to act between rotor 3 and hub 8, and thus, it is possible to transmit the torque of rotor 3 to hub 8 accurately. Accordingly, it is possible to suppress an occurrence of a malfunction (for example, rattling, or the like) of hub 8.

Further, the first feature makes it possible to close a gap between rotor 3 and hub 8. Accordingly, it is possible to prevent foreign matter (for example, water, dust, or the like) from entering in-wheel motor 1 through the gap.

The second feature is that in-wheel motor 1 is an in-wheel motor of an outer rotor type, and includes: inner resolver 18 which detects the rotational state of rotor 3; hub 8 which is attachable to and detachable from rotor 3 (specifically, rotor case 6) and is provided with inner resolver 18 on a surface facing the inner circumferential surface of stator 2 (specifically, stator body 4); and the positioning part that defines a positional relationship between inner resolver 18 and magnet 7 of rotor 3 such that a phase difference between inner resolver 18 and magnet 7 reaches a set value when hub 8 is attached to rotor 3.

The second feature makes it easier to perform phase matching of inner resolver 18 provided in hub 8 and magnet 7 provided in rotor 3 in a case where rotor 3 secured to hub 8 is once detached from rotor 3 and is reattached to rotor 3 for maintenance (for example, replacement of hub 8 itself, and replacement of outer hub bearing 15 and/or inner hub bearing 16 provided in hub 8, or the like).

The third feature is that in-wheel motor 1 is an in-wheel motor of an outer rotor type, and includes: inner resolver 18 which detects the rotational state of rotor 3; and hub 8 which is attachable to and detachable from rotor 3 (specifically, rotor case 6) and is provided with inner resolver 18 on a surface facing the inner circumferential surface of stator 2 (specifically, stator body 4).

Assuming that inner resolver 18 is attached to rotor 3 (for example, the inner side surface of rotor case 6; for example, the portion surrounded by the dashed line illustrated in FIG. 2) in in-wheel motor 1 of an outer rotor type, inner resolver 18 is disposed near coil 5, and a malfunction may occur in inner resolver 18 due to the influence of magnetic flux or the like. The third feature described above, on the other hand, makes it possible to ensure a larger distance between inner resolver 18 and coil 5, and thus, it is possible to suppress the malfunction described above.

Further, the fourth feature is that in-wheel motor 1 having the third feature described above further includes: shaft 12 which is secured to stator 2 and is inserted into the tubular body of hub 8; and inner hub bearing 16 provided between the outer circumferential surface of shaft 12 and the inner circumferential surface of the tubular body of hub 8, and inner resolver 18 is provided close to inner hub bearing 16 in the axial direction of the tubular body of hub 8.

The fourth feature causes the rotation to be stable in a portion in hub 8, in which inner hub bearing 16 is installed (the portion includes the vicinity of inner hub bearing 16), due to the support action of inner hub bearing 16, and thus, the clearance between inner resolver 18 and outer resolver 17 is less likely to be displaced, and it is possible to ensure the accuracy of the detection of the rotational state.

Further, the fifth feature is that in in-wheel motor 1 having the third feature described above, inner hub bearing 16 is provided in contact with the stepped portion of shaft 12.

The fifth feature causes the movement in the axial direction of hub 8 (the wheel assembly width direction) to be suppressed, and thus, it is possible to suppress deviation of inner resolver 18 and outer resolver 17 from each other in the axial direction, and it is possible to ensure the accuracy of the detection of the rotational state.

Note that, the present disclosure is not limited to the embodiment described above, and various variations can be made without departing from the gist thereof. Hereinafter, variations will be described.

The sizes and shapes of the respective components illustrated in FIGS. 1 to 5 are not limited to the illustrated aspects.

In the embodiment, a case where inner resolver 18 is provided in the leading-end portion of the tubular body of hub 8 has been described as an example, but the present disclosure is not limited thereto. Inner resolver 18 may be provided, for example, on the outer circumferential surface of the tubular body of hub 8, in a position which is other than the leading-end portion and is close to inner hub bearing 16. The above position is, for example, a position that makes it possible to maintain the clearance between inner resolver 18 and outer resolver 17 at a defined value (or to suppress the displacement amount of the clearance within a defined range). Note that, even in that case, it goes without saying that outer resolver 17 is disposed corresponding to the position of inner resolver 18.

In the embodiment, a case where positioning pin 25 which is attachable to and detachable from both rotor case 6 and hub 8 is used as the positioning part has been described as an example, but the present disclosure is not limited thereto. For example, a protrusion part (an example of a fitting part) provided in a secured manner in either rotor case 6 or hub 8 may also be used instead of positioning pin 25. In that case, either rotor case 6 or hub 8, in which the protrusion part is not provided, is provided with a hole (an example of the fitted portion) into which the protrusion part is inserted. The protrusion part and the hole are provided in positions such that inner resolver 18 and magnet 7 have the defined positional relationship when hub 8 to which inner resolver 18 is attached (see FIG. 5) is assembled to rotor case 6 to which magnet 7 is attached (see FIG. 4).

The present application is based on a Japanese Patent Application (Japanese Patent Application No. 2021-187894), filed on Nov. 18, 2021, the entire content of which is incorporated herein by reference.

### Industrial Applicability

The present disclosure is useful for an in-wheel motor of an outer rotor type that is mounted in a driving wheel of a vehicle.

### REFERENCE SIGNS LIST

1 In-wheel motor
2 Stator
3 Rotor
4 Stator body
5 Coil
6 Rotor case
7 Magnet
8 Hub
9 Cap
12 Shaft
15 Outer hub bearing
16 Inner hub bearing
17 Outer resolver
18 Inner resolver
19 Wheel
20 Tire
21 Stud bolt
22 Nut
23 Friction seal
24 Bolt
25 Positioning pin
26 Positioning pin hole
100 Wheel assembly

1. An in-wheel motor of an outer rotor type including a stator and a rotor, the in-wheel motor comprising:
a sensor which detects a rotational state of the rotor;
an attachable/detachable member which is attachable to and detachable from the rotor and is provided with the sensor on a surface facing an inner circumferential surface of the stator; and
a positioning part that defines a positional relationship between the sensor and a magnet of the rotor such that a phase difference between the sensor and the magnet reaches a set value when the attachable/detachable member is attached to the rotor.

2. The in-wheel motor according to claim 1, wherein:
the positioning part includes:
a fitted part provided in each of the rotor and the attachable/detachable member; and
a fitting member which is attachable to and detachable from the rotor and the attachable/detachable member and is fitted into the fitted part.

3. The in-wheel motor according to claim 1, wherein
the positioning part includes:
a fitted part provided in one of the rotor and the attachable/detachable member; and
a fitting part which is provided on a side of another one of the rotor and the attachable/detachable member and is fitted into the fitted part, the other one of the rotor and the attachable/detachable member not being the rotor or the attachable/detachable member in which the fitted part is formed.
